(19) United States
(12) Patent Application Publication
(10) Pub. No.: US 2024/0250827 A1
(43) Pub. Date: Jul. 25, 2024

(54) AUTOMATIC TRANSFER OF ELECTRONIC SIGNATURE

(71) Applicant: INTERNATIONAL BUSINESS MACHINES CORPORATION, ARMONK, NY (US)

(72) Inventors: Logan Bailey, Atlanta, GA (US); Zachary A. Silverstein, Georgetown, TX (US); Melanie Dauber, Oceanside, NY (US); Jeremy R. Fox, Georgetown, TX (US); Jacob Ryan Jepperson, St. Paul, MN (US)

(21) Appl. No.: 18/157,856

(22) Filed: Jan. 23, 2023

(51) Int. Cl. H04L 9/32

(52) U.S. Cl. CPC H04L 9/3247; G06Q 10/083

(57) ABSTRACT

A processor identify that a parcel is within a predetermined proximity of a location. The processor may remotely trigger a transfer of signature data associated with the signature. The transfer of the signature data may be from a camera via proximity-based device, and the proximity-based device may be programmed with the predetermined proximity. The processor may allow release of the parcel.

### BACKGROUND

The present disclosure relates generally to the field of supply chain, and more specifically to digitally transferring a signature constrained by proximity to accept delivery for a parcel.

In many instances, especially with high value packaged goods, shippers may require signature confirmation of delivery to decrease risk of fraud, theft, or to meet regulatory requirements. In specific situations, a signature for delivery is mandated by regulation, for instance, certified mail typically includes recipient signature, name, delivery date, time, and address as proof that a package delivery was received. Additionally, certain carriers may provide recipients an option to redirect, or to digitally sign to release packages online prior to delivery. This option, however, only shifts the risk associated with non-delivery to the recipient.

### SUMMARY

Embodiments of the present disclosure include a method, computer program product, and system for digitally transferring a signature constrained by proximity to accept delivery for a parcel. A processor identify that a parcel is within a predetermined proximity of a location. The processor may remotely trigger a transfer of signature data associated with the signature. The transfer of the signature data may be from a camera via proximity-based device, and the proximity-based device may be programmed with the predetermined proximity. The processor may allow release of the parcel.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram illustrating an embodiment of a computer system and the components thereof, upon which embodiments described herein may be implemented in accordance with the present disclosure.

FIG. 2 depicts a block diagram illustrating an extension of the computing system environment of FIG. 1, wherein the computer systems are configured to operate in a network environment (including a cloud environment), and perform methods described herein in accordance with the present disclosure.

FIG. 3 illustrates a block diagram of an example system for digitally transferring a signature constrained by proximity to accept delivery for a parcel, in accordance with aspects of the present disclosure.

FIG. 4 illustrates a flowchart of an example method for digitally transferring a signature constrained by proximity to accept delivery for a parcel, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of supply chain, and more specifically to digitally transferring a signature constrained by proximity to accept delivery for a parcel. While the present disclosure is not necessarily limited to such applications, various aspects of the disclosure may be appreciated through a discussion of various examples using this context.

In many instances, especially with high value packaged goods, shippers may require signature confirmation of delivery to decrease risk of fraud, theft, or to meet regulatory requirements. In specific situations, a signature for delivery is mandated by regulation, for instance, certified mail typically includes recipient signature, name, delivery date, time, and address as proof that a package delivery was received. Additionally, certain carriers may provide recipients an option to redirect, or to digitally sign to release packages online prior to delivery. This option, however, only shifts the risk associated with non-delivery to the recipient. Accordingly, what is needed is a digital solution to sign for parcel delivery directly linked to a recipient's residence. As such, discussed herein is a solution that details how a package/parcel can be accepted with a digital signature without requiring an individual recipient to be present.

Such a solution described herein may include a system and method for digitally transferring a signature constrained by proximity (e.g., a geofenced location, a predetermined location/proximity, etc.) to accept delivery for a parcel. Additionally, such a solution may involve the use of a module/device/system that may allow for the remote triggering of a transfer of a (verifiable) signature or signature data from a camera, or the module, via proximity-based means such as, but not limited to: Radio Frequency Identification (RFID), Near Field Communication (NFC), Bluetooth, etc.

In some embodiments, the solution, utilizing the module/device/system/etc., may detect a corresponding hardware device within the proximity and notify a registered/authorized user/owner device via means such as, but not limited to: mobile push notifications, text messages, an integrated communication application, etc. In some embodiments, the authorized user may utilize their mobile device, or any registered device associated with the user, to instruct release of the verifiable signature or signature data over an internet protocol suite (TCP/IP).

In some embodiments, release of the verifiable signature or signature data may include, but is not limited to: a digital representation of a user's physical signature, a cryptographically verifiable signature/signature data linked to a registered user on a central or distributed database (e.g., blockchain), a unique identifiable device data such as a MAC address, a shared secret with a verifying device, etc. In some embodiments, the solution, via the module/device/system/etc., may capture and store event data or parcel specific information, such as a barcode, QR code, package dimensions, timestamp for delivery, etc. In such an embodiment, verification of the correct parcel and or verification of delivery of the parcel can be confirmed.

As an example, suppose Jessica opts-into the proposed solution when she signs on to her mobile device. She then sets up her digital interface for her smart doorbell that is located at her business. A delivery driver then arrives at the business with an important and time critical package that she has been waiting for. This vital package does require a signature, as it's a high value asset. Upon signing into her mobile device application, Jessica is authenticated as being who she claims to be. This allows for a point of presence to be established for her physical proxy (e.g., the mobile application validates that the real Jessica is “signing” for package, albeit remotely/digitally). Jessica now receives that package with the digital signature (e.g., the driver is allowed to release the package at the business location due to the digital signature).

In some embodiments, the digital signature is passed from Jessica's device over to the delivery driver, all with a non-touch policy for involvement (e.g., the solution may include a module that transmits Jessica's digital signature/signature data to a device associated with the driver that allows release of the package). In some embodiments, the courier's device receives the digital notification that Jessica has reviewed her device and allowed her digital signature to be accepted by courier's device. This allows Jessica to receive the package from the driver and conduct the transaction without being present at the door when the package arrives.

Before turning to the FIGS. it is noted that various aspects of the present disclosure are described by narrative text, flowcharts, block diagrams of computer systems and/or block diagrams of the machine logic included in computer program product (CPP) embodiments. With respect to any flowcharts (depending upon the technology involved) the operations can be performed in a different order than what is shown in the flowchart. For example, two operations shown in successive flowchart blocks may be performed in reverse order, as a single integrated step, concurrently, or in a manner at least partially overlapping in time. A computer program product embodiment (“CPP embodiment”) is a term used in the present disclosure that may describe any set of one or more storage media (or “mediums”) collectively included in a set of one or more storage devices. The storage media may collectively include machine readable code corresponding to instructions and/or data for performing computer operations. A “storage device” may refer to any tangible hardware or device that can retain and store instructions for use by a computer processor. Without limitation, the computer readable storage medium may include an electronic storage medium, a magnetic storage medium, an optical storage medium, an electromagnetic storage medium, a semiconductor storage medium, a mechanical storage medium, and/or any combination thereof. Some known types of storage devices that include mediums referenced herein may include a diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination thereof. A computer-readable storage medium should not be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As understood by those skilled in the art, data is typically moved at some occasional points in time during normal operations of a storage device, such as during access, de-fragmentation or garbage collection, but this does not render the storage device as transitory because the data is not transitory while it is stored.

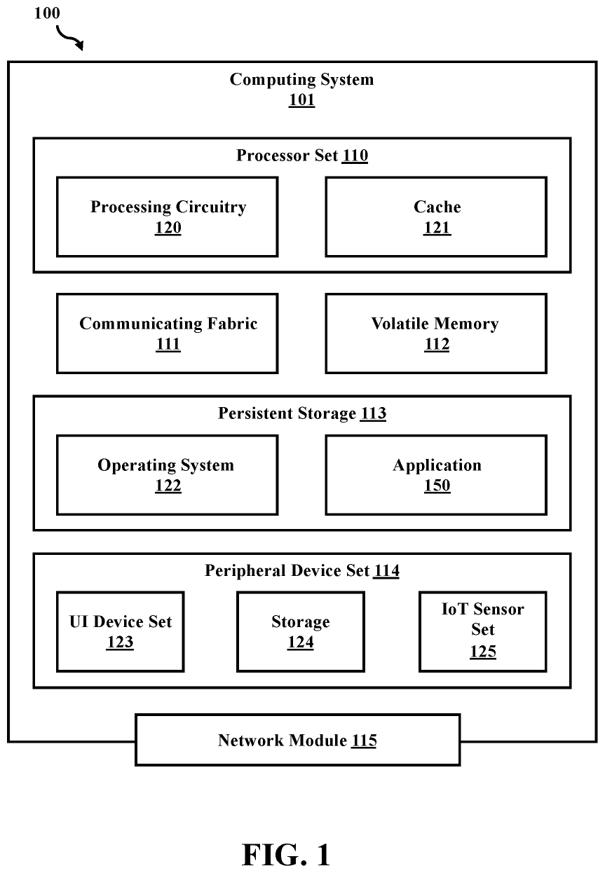

Referring now to FIG. 1, illustrated is a block diagram describing an embodiment of a computing system 101 within in a computing environment, which may be a simplified example of a computing device (i.e., a physical bare metal system and/or a virtual system) capable of performing the computing operations described herein. Computing system 101 may be representative of the one or more computing systems or devices implemented in accordance with the embodiments of the present disclosure and further described below in detail. It should be appreciated that FIG. 1 provides only an illustration of one implementation of a computing system 101 and does not imply any limitations regarding the environments in which different embodiments may be implemented. In general, the components illustrated in FIG. 1 may be representative of an electronic device, either physical or virtualized, capable of executing machine-readable program instructions.

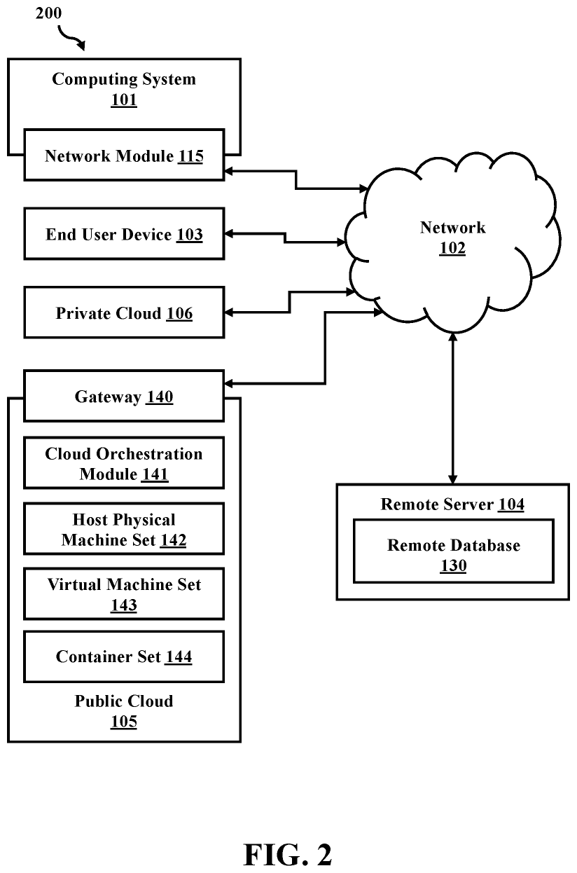

Embodiments of computing system 101 may take the form of a desktop computer, laptop computer, tablet computer, smart phone, smart watch or other wearable computer, mainframe computer, server, quantum computer, a non-conventional computer system such as an autonomous vehicle or home appliance, or any other form of computer or mobile device now known or to be developed in the future that is capable of running a program 150, accessing a network 102 or querying a database, such as remote database 130. Performance of a computer-implemented method executed by a computing system 101 may be distributed among multiple computers and/or between multiple locations. Computing system 101 may be located as part of a cloud network, even though it is not shown within a cloud in FIGS. 1-2. Moreover, computing system 101 is not required to be in a cloud network except to any extent as may be affirmatively indicated.

Processor set 110 includes one, or more, computer processors of any type now known or to be developed in the future. Processing circuitry 120 may be distributed over multiple packages. For example, multiple, coordinated integrated circuit chips. Processing circuitry 120 may implement multiple processor threads and/or multiple processor cores. Cache 121 may refer to memory that is located on the processor chip package(s) and/or may be used for data or code that can be made available for rapid access by the threads or cores running on processor set 110. Cache 121 memories can be organized into multiple levels depending upon relative proximity to the processing circuitry 120. Alternatively, some, or all of cache 121 of processor set 110 may be located “off chip.” In some computing environments, processor set 110 may be designed for working with qubits and performing quantum computing.

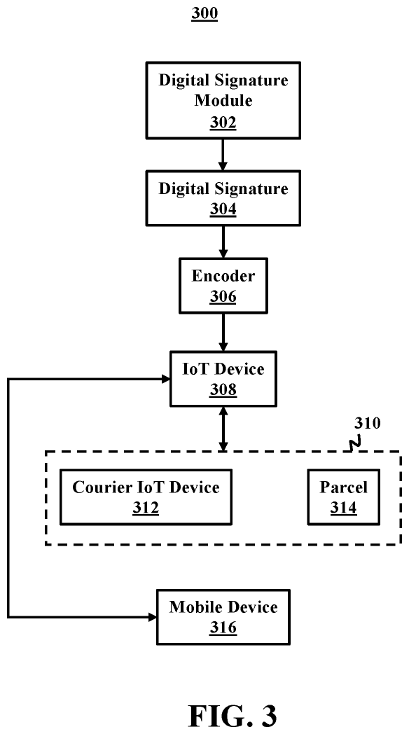

Computer readable program instructions can be loaded onto computing system 101 to cause a series of operational steps to be performed by processor set 110 of computing system 101 and thereby implement a computer-implemented method. Execution of the instructions can instantiate the methods specified in flowcharts and/or narrative descriptions of computer-implemented methods included in this specification (collectively referred to as “the inventive methods”). The computer readable program instructions can be stored in various types of computer readable storage media, such as cache 121 and the other storage media discussed herein. The program instructions, and associated data, can be accessed by processor set 110 to control and direct performance of the inventive methods. In computing environments of FIGS. 1-2, at least some of the instructions for performing the inventive methods may be stored in persistent storage 113, volatile memory 112, and/or cache 121, as application(s) 150 comprising one or more running processes, services, programs and installed components thereof. For example, program instructions, processes, services and installed components thereof may include the components and/or sub-components of the system 300 as shown in FIG. 3.

Communication fabric 111 may refer to signal conduction paths that may allow the various components of computing system 101 to communicate with each other. For example, communications fabric 111 can provide for electronic communication among the processor set 110, volatile memory 112, persistent storage 113, peripheral device set 114 and/or network module 115. Communication fabric 111 can be made of switches and/or electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 may refer to any type of volatile memory now known or to be developed in the future, and may be characterized by random access, but this is not required unless affirmatively indicated. Examples include dynamic type random access memory (RAM) or static type RAM. In computing system 101, the volatile memory 112 is located in a single package and can be internal to computing system 101, but, alternatively or additionally, the volatile memory 112 may be distributed over multiple packages and/or located externally with respect to computing system 101. Application 150, along with any program(s), processes, services, and installed components thereof, described herein, may be stored in volatile memory 112 and/or persistent storage 113 for execution and/or access by one or more of the respective processor sets 110 of the computing system 101.

Persistent storage 113 can be any form of non-volatile storage for computers that may be currently known or developed in the future. The non-volatility of this storage means that the stored data may be maintained regardless of whether power is being supplied to computing system 101 and/or directly to persistent storage 113. Persistent storage 113 may be a read only memory (ROM), however, at least a portion of the persistent storage 113 may allow writing of data, deletion of data and/or re-writing of data. Some forms of persistent storage 113 may include magnetic disks, solid-state storage devices, hard drives, flash-based memory, erasable read-only memories (EPROM) and semi-conductor storage devices. Operating system 122 may take several forms, such as various known proprietary operating systems or open-source Portable Operating System Interface type operating systems that employ a kernel.

Peripheral device set 114 includes one or more peripheral devices connected to computing system 101. For example, via an input/output (I/O interface). Data communication connections between the peripheral devices and the other components of computing system 101 may be implemented using various methods. For example, through connections using Bluetooth, Near-Field Communication (NFC), wired connections or cables (such as universal serial bus (USB) type cables), insertion type connections (for example, secure digital (SD) card), connections made though local area communication networks and/or wide area networks such as the internet. In various embodiments, UI device set 123 may include components such as a display screen, speaker, microphone, wearable devices (such as goggles, headsets and smart watches), keyboard, mouse, printer, touchpad, game controllers, and haptic feedback devices. Storage 124 can include external storage, such as an external hard drive, or insertable storage, such as an SD card. Storage 124 may be persistent and/or volatile. In some embodiments, storage 124 may take the form of a quantum computing storage device for storing data in the form of qubits. In some embodiments, networks of computing systems 101 may utilize clustered computing and components acting as a single pool of seamless resources when accessed through a network by one or more computing systems 101. For example, a storage area network (SAN) that is shared by multiple, geographically distributed computer systems 101 or network-attached storage (NAS) applications. IoT sensor set 125 can be made up of sensors that can be used in Internet-of-Things applications. For example, a sensor may be a temperature sensor, motion sensor, infrared sensor or any other type of known sensor type.

Network module 115 may include a collection of computer software, hardware, and/or firmware that allows computing system 101 to communicate with other computer systems through a network 102, such as a LAN or WAN. Network module 115 may include hardware, such as modems or Wi-Fi signal transceivers, software for packetizing and/or de-packetizing data for communication network transmission, and/or web browser software for communicating data over the network. In some embodiments, network control functions and network forwarding functions of network module 115 are performed on the same physical hardware device. In other embodiments (for example, embodiments that utilize software-defined networking (SDN)), the control functions and the forwarding functions of network module 115 can be performed on physically separate devices, such that the control functions manage several different network hardware devices. Computer readable program instructions for performing the inventive methods can typically be downloaded to computing system 101 from an external computer or external storage device through a network adapter card or network interface included in network module 115.

Continuing, FIG. 2 depicts a computing environment 200 which may be an extension of the computing environment 100 of FIG. 1, operating as part of a network. In addition to computing system 101, computing environment 200 can include a network 102 such as a wide area network (WAN) (or another type of computer network) connecting computing system 101 to an end user device (EUD) 103, remote server 104, public cloud 105, and/or private cloud 106. In this embodiment, computing system 101 includes processor set 110 (including processing circuitry 120 and cache 121), communication fabric 111, volatile memory 112, persistent storage 113 (including operating system 122 and program(s) 150, as identified above), peripheral device set 114 (including user interface (UI), device set 123, storage 124, Internet of Things (IoT) sensor set 125), and network module 115. Remote server 104 includes remote database 130. Public cloud 105 includes gateway 140, cloud orchestration module 141, host physical machine set 142, virtual machine set 143, and/or container set 144.

Network 102 may be comprised of wired or wireless connections. For example, connections may be comprised of computer hardware such as copper transmission cables, optical transmission fibers, wireless transmission, routers, firewalls, switches, gateway computers and/or edge servers. Network 102 may be described as any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. Other types of networks that can be used to interconnect the various computer systems 101, end user devices 103, remote servers 104, private cloud 106 and/or public cloud 105 may include Wireless Local Area Networks (WLANs), home area network (HAN), backbone networks (BBN), peer to peer networks (P2P), campus networks, enterprise networks, the Internet, single tenant or multi-tenant cloud computing networks, the Public Switched Telephone Network (PSTN), and any other network or network topology known by a person skilled in the art to interconnect computing systems 101.

End user device 103 can include any computer device that can be used and/or controlled by an end user (for example, a customer of an enterprise that operates computing system 101) and may take any of the forms discussed above in connection with computing system 101. EUD 103 may receive helpful and useful data from the operations of computing system 101. For example, in a hypothetical case where computing system 101 is designed to provide a recommendation to an end user, this recommendation may be communicated from network module 115 of computing system 101 through WAN 102 to EUD 103. In this example, EUD 103 can display, or otherwise present, the recommendation to an end user. In some embodiments, EUD 103 may be a client device, such as thin client, thick client, mobile computing device such as a smart phone, mainframe computer, desktop computer and so on.

Remote server 104 may be any computing systems that serves at least some data and/or functionality to computing system 101. Remote server 104 may be controlled and used by the same entity that operates computing system 101. Remote server 104 represents the machine(s) that collect and store helpful and useful data for use by other computers, such as computing system 101. For example, in a hypothetical case where computing system 101 is designed and programmed to provide a recommendation based on historical data, the historical data may be provided to computing system 101 from remote database 130 of remote server 104.

Public cloud 105 may be any computing systems available for use by multiple entities that provide on-demand availability of computer system resources and/or other computer capabilities including data storage (cloud storage) and computing power, without direct active management by the user. The direct and active management of the computing resources of public cloud 105 can be performed by the computer hardware and/or software of cloud orchestration module 141. The computing resources provided by public cloud 105 can be implemented by virtual computing environments that run on various computers making up the computers of host physical machine set 142, and/or the universe of physical computers in and/or available to public cloud 105. The virtual computing environments (VCEs) may take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through network 102.

VCEs can be stored as “images.” A new active instance of the VCE can be instantiated from the image. Two types of VCEs may include virtual machines and containers. A container is a VCE that uses operating-system-level virtualization, in which the kernel allows the existence of multiple isolated user-space instances, called containers. These isolated user-space instances may behave as physical computers from the point of view of programs 150 running in them. An application 150 running on an operating system 122 can utilize all resources of that computer, such as connected devices, files and folders, network shares, CPU power, and quantifiable hardware capabilities. Applications 150 running inside a container of container set 144 may only use the contents of the container and devices assigned to the container, a feature which may be referred to as containerization.

Private cloud 106 may be similar to public cloud 105, except that the computing resources may only be available for use by a single enterprise. While private cloud 106 is depicted as being in communication with network 102 (such as the Internet), in other embodiments a private cloud 106 may be disconnected from the internet entirely and only accessible through a local/private network. A hybrid cloud may refer to a composition of multiple clouds of different types (for example, private, community or public cloud types), and the plurality of clouds may be implemented or operated by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 may be both part of a larger hybrid cloud environment.

Referring now to FIG. 3, illustrated is a block diagram of an example system 300 for digitally transferring a signature constrained by proximity to accept delivery for a parcel, in accordance with aspects of the present disclosure.

As depicted, the system 300 includes a digital signature module 302 (e.g., a processor, an ASIC, etc.), a digital signature 304, an encoder 306, an internet-of-things (IoT) device 308, a proximity 310, a courier IoT device 312, a parcel 314, and a mobile device 316.

In some embodiments, a user (not depicted) opts-in to utilize the digital signature module 302. The user then creates the digital signature 304, which is generated and stored by the digital signature module 302. In some embodiments, the digital signature 304 is b64 encoded by the encoder 306.

In some embodiments, the digital signature module 302 is integrated into, or communicates with, the IoT Device 308 (e.g., a smart doorbell, camera, etc.). In some embodiments, the digital signature module 302 is provided with delivery/package/parcel information from the user, or the user opts into having the information automatically provided to the digital signature module 302. In some embodiments, the IoT device 308 is given the proximity 310, which may be set by the user or automatically set by the digital signature module 302 (e.g., within 5 ft of a door, within a foot of a reception desk, etc.).

In some embodiments, the IoT device 308 may identify that the courier IoT device 312 is within the proximity 312. The IoT device 308, by way of the digital signature module 302, checks to see if a parcel needing signature delivery is to be delivered that day, or within a time within a delivery window (e.g., in the next 2 days, the next 3 days, between 8 am and 11 am, etc.). If a parcel is not to delivered, the IoT device 308 may continue to function in its normal capacity (e.g., as a smart doorbell, as a recording device, etc.). If the IoT device 308 does determine that the courier IoT device 312 and the parcel 314, which is to be delivered and needing signature, is within the proximity 310, the IoT device 312 communicates with the courier IoT device 312.

In some embodiments, either after communicating with the courier IoT device 312, or simultaneously to communicating with the courier IoT device 312, the IoT device 312 (or the digital signature module 302, communicates with the mobile device 316 of the user. The mobile device 316 provides a prompt (e.g., provide password, provide thumbprint, etc.) to the user to authorize release of their digital signature 304. If the user provides release of the digital signature 304, the courier IoT device 312 is provided the digital signature 304, and the parcel 314 is released by the courier. Accordingly, the parcel 314 is delivered without the user being physically present and without a physical signature needed to be provided by the user.

In some embodiments, the IoT device 312 captures other key information such as time of delivery, a package/parcel image, and/or a courier image to confirm delivery of the parcel 314. In some embodiments, if the recipient/user is in the proximity 310 (e.g., there in person), a physical signature may be captured as an image by the IoT device 312, and used as confirmation of delivery of the parcel 314.

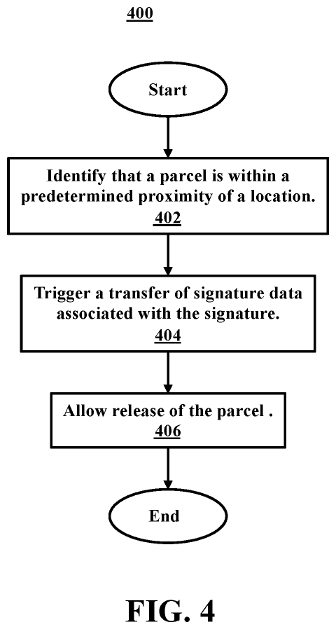

Referring now to FIG. 4, illustrated is a flowchart of an example method 400 for digitally transferring a signature constrained by proximity to accept delivery for a parcel, in accordance with aspects of the present disclosure. In some embodiments, the method 400 may be performed by a processor (e.g., of the system 300 of FIG. 3, etc.).

In some embodiments, the method 400 begins at operation 402, where the processor identifies that a parcel is within a predetermined proximity of a location. In some embodiments, the method 400 proceeds to operation 404, where the processor remotely triggers a transfer of signature data associated with the signature. The transfer of the signature data may be from a camera via proximity-based device (e.g., the IoT device 308), and the proximity-based device may be programmed with the predetermined proximity (e.g., the proximity 310). In some embodiments, the method 400 proceeds to operation 406, where the processor allows release of the parcel.

In some embodiments, discussed below, there are one or more operations of the method 400 not depicted for the sake of brevity and which are discussed throughout this disclosure. Accordingly, in some embodiments, the method 400 may further comprise the processor generating a notification, where the generation of the notification is in response to the triggering of the transfer of the signature data, and the processor may push the notification to a device associated with a user.

In some embodiments, the method 400 may further comprise the processor receiving, from the user, an authorization, where the authorization may allow release of the signature data over Transmission Control Protocol/Internet Protocol (TCP/IP), and the processor may release the signature data over TCP/IP. In some embodiments, release of the signature data may include the processor verifying the authorization based on one or more security procedures.

In some embodiments, one of the one or more security procedures is a cryptographically verifiable signature data linked to the user on a distributed database (e.g., blockchain). In some embodiments, one of the one or more security procedures is unique identifiable data associated with the device (e.g., a MAC address, etc.) associated with the user.

In some embodiments, the method 400 may further comprise the processor capturing a snapshot (image) of the parcel, identifying, from the snapshot, metrics of the parcel (e.g., dimensions, pictures on the outside packaging, a barcode, etc.), validating the parcel, and storing event data associated with the parcel. In some embodiments, validating the parcel includes verifying metrics from the snapshot are consistent with the parcel (e.g., a 65 in TV to be delivered is not in a box that is only 12 in by 12 in, etc.). In some embodiments, storing the event data associated with the parcel includes the snapshot and metadata of the snapshot (e.g., the size of the parcel in the snapshot, the condition of the parcel in the snapshot, etc.).

It is noted that the descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A system for digitally transferring a signature constrained by proximity to accept delivery for a parcel, the system comprising:
a memory; and
a processor in communication with the memory, the processor being configured to perform operations comprising:
identifying that a parcel is within a predetermined proximity of a location;
triggering, remotely by the processor, a transfer of signature data associated with the signature, wherein the transfer of the signature data is from a camera via proximity-based device, wherein the proximity-based device is programmed with the predetermined proximity; and
allowing release of the parcel.

2. The system of claim 1, wherein the processor is further configured to perform operations comprising:
generating a notification, wherein the generation of the notification is in response to the triggering of the transfer of the signature data; and
pushing the notification to a device associated with a user.

3. The system of claim 2, wherein the processor is further configured to perform operations comprising:
receiving, from the user, an authorization, wherein the authorization allows release of the signature data over Transmission Control Protocol/Internet Protocol (TCP/IP); and
releasing the signature data over TCP/IP.

4. The system of claim 3, wherein release of the signature data includes:
verifying the authorization based on one or more security procedures.

5. The system of claim 4, wherein one of the one or more security procedures is a cryptographically verifiable signature data linked to the user on a distributed database.

6. The system of claim 5, wherein one of the one or more security procedures is unique identifiable data associated with the device associated with the user.

7. The system of claim 1, wherein the processor is further configured to perform operations comprising:
capturing a snapshot of the parcel;
identifying, from the snapshot, metrics of the parcel;
validating the parcel; and
storing event data associated with the parcel.

8. A computer-implemented method for digitally transferring a signature constrained by proximity to accept delivery for a parcel, the method comprising:
identifying, by a processor, that a parcel is within a predetermined proximity of a location;
triggering, remotely by the processor, a transfer of signature data associated with the signature, wherein the transfer of the signature data is from a camera via proximity-based device, wherein the proximity-based device is programmed with the predetermined proximity; and
allowing release of the parcel.

9. The method of claim 8, further comprising:
generating a notification, wherein the generation of the notification is in response to the triggering of the transfer of the signature data; and
pushing the notification to a device associated with a user.

10. The method of claim 9, further comprising:
receiving, from the user, an authorization, wherein the authorization allows release of the signature data over Transmission Control Protocol/Internet Protocol (TCP/IP); and
releasing the signature data over TCP/IP.

11. The method of claim 10, wherein release of the signature data includes:
verifying the authorization based on one or more security procedures.

12. The method of claim 11, wherein one of the one or more security procedures is a cryptographically verifiable signature data linked to the user on a distributed database.

13. The method of claim 12, wherein one of the one or more security procedures is unique identifiable data associated with the device associated with the user.

14. The method of claim 8, further comprising:
capturing a snapshot of the parcel;
identifying, from the snapshot, metrics of the parcel;
validating the parcel; and
storing event data associated with the parcel.

15. A computer program product for storing data that devalues the data when compromised comprising a computer readable storage medium having program instructions embodied therewith, the program instructions executable by a processor to cause the processor to perform operations, the operations comprising:
identifying that a parcel is within a predetermined proximity of a location;
triggering, remotely by the processor, a transfer of signature data associated with the signature, wherein the transfer of the signature data is from a camera via proximity-based device, wherein the proximity-based device is programmed with the predetermined proximity; and
allowing release of the parcel.

16. The computer program product of claim 15, wherein the processor is further configured to perform operations comprising:
generating a notification, wherein the generation of the notification is in response to the triggering of the transfer of the signature data; and
pushing the notification to a device associated with a user.

17. The computer program product of claim 16, wherein the processor is further configured to perform operations comprising:
receiving, from the user, an authorization, wherein the authorization allows release of the signature data over Transmission Control Protocol/Internet Protocol (TCP/IP); and
releasing the signature data over TCP/IP.

18. The computer program product of claim 17, wherein release of the signature data includes:
verifying the authorization based on one or more security procedures.

19. The computer program product of claim 18, wherein one of the one or more security procedures is a cryptographically verifiable signature data linked to the user on a distributed database.

20. The computer program product of claim 19, wherein one of the one or more security procedures is unique identifiable data associated with the device associated with the user.
